(19) United States
(12) Patent Application Publication
(10) Pub. No.: US 2014/0263211 A1
(43) Pub. Date: Sep. 18, 2014

(54) Methods for Trimming Display Polarizers Using Lasers

(71) Applicant: Apple Inc., Cupertino, CA (US)

(72) Inventors: Mohd Fadzli A. Hassan, San Francisco, CA (US); Nathan K. Gupta, San Francisco, CA (US); Yu-Cheng Chen, San Jose, CA (US); Kuan-Ying Lin, Mountain View, CA (US)

(73) Assignee: Apple Inc., Cupertino, CA (US)

(21) Appl. No.: 14/195,707

(22) Filed: Mar. 3, 2014

Related U.S. Application Data
(60) Provisional application No. 61/800,461, filed on Mar. 15, 2013.

(51) Int. Cl. B23K 26/40; B23K 26/03

(52) U.S. Cl. CPC B23K 26/4025; B23K 26/03
USPC 219/121.69; 219/121.81

(57) ABSTRACT

A display such as a liquid crystal display has a display substrate that includes a layer of liquid crystal material sandwiched between a color filter layer and a thin-film-transistor layer. An oversized polarizer is laminated to the surface of the display substrate. Laser-based polarizer trimming equipment is used to trim away excess portions of the polarizer from the display substrate. A thickness gauge gathers thickness information from the laminated polarizer and display substrate. The thickness information is used to adjust the position of a laser relative to the polarizer during polarizer trimming operations. The laser beam moves along a cutting path that is unique to the display substrate. A vision system performs an inspection to determine whether the display substrate is damaged following polarizer trimming operations. Based on the inspection, laser parameters may be adjusted prior to performing polarizer trimming operations on additional polarizers and display substrates.

This application claims priority to U.S. provisional patent application No. 61/800,461 filed Mar. 15, 2013, which is hereby incorporated by reference herein in its entirety.

### BACKGROUND

This relates generally to electronic devices and, more particularly, to electronic devices with displays.

Electronic devices often include displays. For example, cellular telephones and portable computers often include displays for presenting information to a user.

Displays such as liquid crystal display have polarizers. The polarizers are formed from polymer layers that are laminated to glass display layers. It may be desirable to ensure that a polarizer layer has the same size as an associated glass display layer. If the polarizer is too large, the edge of the polarizer will overhang the edge of the glass display layer, which in turn can lead to polarizer peeling. If the polarizer is too small, the edge of the display will have an unsightly visible polarizer edge. Although the polarizer edge may be covered with a plastic bezel, the use of a bezel reduces the visible area of a display and can make the display unattractive.

It would therefore be desirable to be able to provide improved displays with polarizers for electronic devices.

### SUMMARY

A display such as a liquid crystal display may have substrate layers such as a thin-film transistor layer and color filter layer. The substrate layers may be sandwiched together to form a rigid glass display substrate. Grinding equipment may be used to polish the edge of the display substrate.

An oversized polarizer layer may be laminated to the surface of the display substrate. Polarizer trimming equipment may be used to trim away excess portions of the polarizer from the display substrate. The polarizer trimming equipment may include a laser and a computer-controlled positioner that moves the laser along a laser cutting path to trim away excess portions of the polarizer without damaging the display substrate.

The polarizer trimming equipment may include a thickness gauge. The thickness gauge may be used to measure a distance between an upper surface of the polarizer and a lower surface of the display substrate (i.e., the thickness of the display stack that includes the laminated polarizer and display substrate). The computer-controlled positioner that controls the laser may adjust the position of the laser relative to the polarizer based on the thickness information gathered by the thickness gauge.

A vision system may be used to perform an inspection of the polarizer edges and of the display substrate edges following polarizer trimming. The vision system may, for example, determine whether or not the display substrate has been damaged during polarizer trimming operations. Based on the inspection, laser parameters may be adjusted prior to performing polarizer trimming operations on additional polarizers and display substrates. For example, if a first set of laser parameters is used to trim a first polarizer from a first display substrate, a second set of laser parameters may be used to trim a second polarizer from a second display substrate. Adjusting laser parameters may include adjusting the location relative to the display substrate at which the laser is turned on as it approaches the designated cutting path. Adjusting laser parameters may also include adjusting the power of the laser and/or adjusting the laser pulse energy.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with display structures in accordance with an embodiment.

FIG. 2 is a perspective view of an illustrative electronic device such as a handheld electronic device with display structures in accordance with an embodiment.

FIG. 3 is a perspective view of an illustrative electronic device such as a tablet computer with display structures in accordance with an embodiment.

FIG. 4 is a perspective view of an illustrative electronic device such as a computer display with display structures in accordance with an embodiment.

FIG. 5 a cross-sectional side view of an illustrative display of the type that may be used in devices of the types shown in FIGS. 1, 2, 3, and 4 in accordance with an embodiment.

FIG. 6 is a cross-sectional side view of an illustrative polarizer layer in accordance with an embodiment.

FIG. 7 is a perspective view of an illustrative panel of display layers that includes display structures for forming multiple individual displays in accordance with an embodiment.

FIG. 8 is a diagram of an illustrative system being used to form individual display layers from a panel of display layers in accordance with an embodiment.

FIG. 9 is a diagram of an illustrative system being used to laminate a polarizer to a display layer in accordance with an embodiment.

FIG. 10 is a diagram of an illustrative polarizer trimming system being used to trim an edge of a polarizer layer on a display substrate in accordance with an embodiment.

FIG. 11 is a side view of an illustrative focusing lens and focused laser beam of the type used in laser trimming a polarizer on a display layer with the equipment of FIG. 10 in accordance with an embodiment.

FIG. 12 is a top view of an illustrative display showing how an oversized polarizer may be trimmed using a computer-controlled laser in accordance with an embodiment.

FIG. 13 is a flow chart of illustrative steps involved in performing polarizer trimming operations in accordance with an embodiment.

### DETAILED DESCRIPTION

Displays in electronic devices such as liquid crystal displays may be provided with polarizers. Illustrative electronic devices that have displays with polarizers are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 to allow upper housing 12A to rotate in directions 22 about rotational axis 24 relative to lower housing 12B. Display 14 is mounted in upper housing 12A. Upper housing 12A, which may sometimes referred to as a display housing or lid, is placed in a closed position by rotating upper housing 12A towards lower housing 12B about rotational axis 24.

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an external layer with an opening to accommodate button 26.

FIG. 4 shows an illustrative configuration for electronic device 10 in which device 10 is a computer display or a computer that has been integrated into a computer display. With this type of arrangement, housing 12 for device 10 is mounted on a support structure such as stand 27. Display 14 is mounted on a front face of housing 12.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, is formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

A cross-sectional side view of an illustrative configuration for display 14 of device 10 (e.g. for display 14 of the devices of FIG. 1, FIG. 2, FIG. 3, FIG. 4 or other suitable electronic devices) is shown in FIG. 5. As shown in FIG. 5, display 14 includes backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 illuminates images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 form a liquid crystal display or may be used in forming displays of other types.

In a configuration in which display layers 46 are used in forming a liquid crystal display, display layers 46 include a liquid crystal layer such a liquid crystal layer 52. Liquid crystal layer 52 is sandwiched between display layers such as display layers 58 and 56. Layers 56 and 58 are interposed between lower polarizer layer 60 and upper polarizer layer 54.

Layers 58 and 56 are formed from transparent substrate layers such as clear layers of glass or plastic. Layers 56 and 58 are layers such as a thin-film transistor layer (e.g. a thin-film-transistor substrate such as a glass layer coated with a layer of thin-film transistor circuitry) and/or a color filter layer (e.g., a color filter layer substrate such as a layer of glass having a layer of color filter elements such as red, blue, and green color filter elements arranged in an array). Conductive traces, color filter elements, transistors, and other circuits and structures are formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 is a thin-film transistor layer that includes an array of thin-film transistors and associated electrodes (display pixel electrodes) for applying electric fields to liquid crystal layer 52 and thereby displaying images on display 14. Layer 56 is a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits such as components 68 on printed circuit 66 of FIG. 5 and/or other circuitry) is used to generate information to be displayed on display 14 (e.g., display data). The information to be displayed is conveyed from circuitry 68 to display driver integrated circuit 62 using a signal path such as a signal path formed from conductive metal traces in flexible printed circuit 64 (as an example).

Display driver circuitry such as display driver integrated circuit 62 of FIG. 5 is mounted on thin-film-transistor layer driver ledge 82 or elsewhere in device 10. A flexible printed circuit cable such as flexible printed circuit 64 is used in routing signals between printed circuit 66 and thin-film-transistor layer 58. If desired, display driver integrated circuit 62 may be mounted on printed circuit 66 or flexible printed circuit 64. Printed circuit 66 is formed from a rigid printed circuit board (e.g., a layer of fiberglass-filled epoxy) or a flexible printed circuit (e.g., a flexible sheet of polyimide or other flexible polymer layer).

Backlight structures 42 include a light guide plate such as light guide plate 78. Light guide plate 78 is formed from a transparent material such as clear glass or plastic. During operation of backlight structures 42, a light source such as light source 72 generates light 74. Light source 72 may be, for example, an array of light-emitting diodes.

Light 74 from one or more light sources such as light source 72 is coupled into one or more corresponding edge surfaces such as edge surface 76 of light guide plate 78 and is distributed in dimensions X and Y throughout light guide plate 78 due to the principal of total internal reflection. Light guide plate 78 includes light-scattering features such as pits or bumps. The light-scattering features are located on an upper surface and/or on an opposing lower surface of light guide plate 78.

Light 74 that scatters upwards in direction Z from light guide plate 78 serves as backlight 44 for display 14. Light 74 that scatters downwards is reflected back in the upwards direction by reflector 80. Reflector 80 is formed from a reflective material such as a layer of white plastic or other shiny materials.

To enhance backlight performance for backlight structures 42, backlight structures 42 include optical films 70. Optical films 70 include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 overlap the other structures in backlight unit 42 such as light guide plate 78 and reflector 80. For example, if light guide plate 78 has a rectangular footprint in the X-Y plane of FIG. 5, optical films 70 and reflector 80 preferably have a matching rectangular footprint.

The outermost layer of display 14 may be a protective display layer such as a layer of glass that covers layers 46 or a display layer such as color filter layer 56 (e.g., a glass substrate layer in layer 56) may serve as the outermost structural layer in display 14. When display layer 56 is used as the outermost substrate layer in display 14, visible border structures in display 14 can be minimized by accurately trimming polarizer 54 along the edge of layer 56. Polarizing trimming operations can be performed using lasers or other trimming equipment. Care should be taken during trimming operations not to damage display layer 56. As an example, care should be taken not to induce thermal damage to a glass substrate in layer 56 during laser trimming operations.

A cross-sectional side view of an illustrative polarizer layer in display 14 is shown in FIG. 6. Polarizer layer 54 of FIG. 6 is an upper polarizer such as upper polarizer 54 of FIG. 5. Lower polarizer layers such as lower polarizer 60 may be constructed similarly.

In the example of FIG. 6, polarizer 54 is formed from multiple layers of material that are attached together. Polarizer film 94 is formed from a stretched polymer such as stretched polyvinyl alcohol (PVA) and may therefore sometimes be referred to as a PVA layer. Iodine may be placed on the stretched PVA film so that iodine molecules align with the stretched film and form the polarizer. Other types of polarizer films may be used if desired.

Polarizer film 94 is sandwiched between layers 92 and 96. Layers 92 and 96 may be formed from a material such as tri-acetyl cellulose (TAC) and may sometimes be referred to as TAC films or may be formed from other polymers. The TAC films may help hold the PVA film in its stretched configuration and may protect the PVA film. Other films may be attached to polarizer film 94 if desired.

Coating layer 90 includes one or more films of material that provide polarizer 54 with desired surface properties. For example, layer 90 may be formed from materials that provide polarizer 54 with antiglare (light diffusing) properties, antireflection properties, scratch resistance, fingerprint resistance, and other desired properties. Layer 90 preferably is formed from one or more layers of material such as antireflection (AR) layers (e.g., films formed from a stack of alternating high-index-of-refraction and low-index-of-refraction layers), antiglare layers, antireflection-antiglare layers, oleophobic layers, antiscratch coatings, and other coating layers. The functions of these layers need not be mutually exclusive. For example, an antiglare film in coating 90 may help provide polarizer 54 with scratch resistance.

Polarizer 54 can be provided with a layer of adhesive such as adhesive layer 98 to help attach polarizer 54 to the upper surface of display layers 46 (i.e. color filter 56 of FIG. 5). The thickness of polarizer 54 may be about 50-200 microns or 90-180 microns (as examples). During manufacturing operations, adhesive 98 attaches polarizer 54 to the upper surface of color filter layer 56.

Trimming operations are preferably used to trim the edge of polarizer 54 to match the edge of color filter layer 56.

Display layers can be formed from larger sheets of material. For example, as shown in FIG. 7, a first oversized glass layer such as layer 560 can include color filter structures for forming multiple color filter layers for multiple displays. A second oversized glass layer such as layer 580 can include thin-film transistor circuitry for forming multiple thin-film transistor layers for multiple displays. Liquid crystal material 520 is sandwiched between oversized glass layer 560 and oversized glass layer 580, thus forming oversized display layer 100 (e.g. a panel of display layers). Oversized display layer 100 therefore includes display structures (e.g., color filter structures, thin-film transistor circuitry, liquid crystal material, and other suitable display structures) for forming multiple individual displays. Layer 100 may include one or more layers of glass, ceramic, polymer, or other suitable substrate materials.

Following formation of oversized display layer 100, layer 100 is divided into smaller pieces. As shown in FIG. 8, equipment such as equipment 122 is used to divide layer 100 into smaller pieces such as substrate 108. Equipment 122 may be substrate cutting equipment such as water-jet cutting equipment, laser cutting equipment, sawing equipment, machining equipment, or other equipment for dividing layer 100 into smaller pieces. In one illustrative configuration, equipment 122 includes a computer-controlled positioner and a scribing tool. The computer-controlled positioner moves the scribing tool in a desired pattern over the surface of layer 100 to form scribe lines. Manual and/or automated equipment is then used to break layer 100 along the scribe lines to form separate pieces of layer 100 such as pieces 106 and 108. Pieces 106 and 108 each have the size and shape of display 14 (e.g., rectangular display-sized pieces of glass).

Following the use of scribing operations or other operations to separate out individual display structures such as display-sized display layer 108 from oversized layer 100 using equipment 122, display substrate processing equipment such as computer-controlled grinding tool 124 is used to help smooth outer edge 110 of display layer 108. As shown in FIG. 8, grinding tool 124 includes a grinding head 114 (e.g., a rotating grinding bit). Positioner 112 may be controlled by control circuitry such as controller 116. Vision system 118 may be used to capture image data of display layer 108 during grinding operations. Based on captured image data (e.g., images of fiducials), controller 116 may adjust the position of grinding head 114 relative to substrate 108 using positioner 112. Head 114 has a surface profile that is configured to ease the sharp corners in layer 108 (e.g., by rounding the upper and lower edges of layer 108, by beveling the upper and lower edges of layer 108, etc.). As shown at the bottom of FIG. 8, grinding tool 124 can provide layer 108 with a machined profile for surface 110 such as rounded profile 120 (e.g., edge 110 can be formed from a curved surface).

Glass layer 108 is used as a display layer for display 14. In the illustrative example of FIG. 8, glass layer 108 includes multiple display layers such as color filter layer 56 and thin-film transistor layer 58. Liquid crystal material 52 is interposed between color filter layer 56 and thin-film-transistor layer 58. This is, however, merely illustrative. If desired, layer 108 may be a color filter layer that has not yet been attached to a thin-film transistor layer or layer 108 may include additional display structures.

Display layer 108 is sometimes referred to herein as glass layer 108. However, it should be understood that layer 108 can include one or more plastic layers, one or more ceramic layers, or one or more layers of other materials. The use of one or more glass layers to form display layer 108 is merely illustrative.

FIG. 9 is a system diagram showing how polarizer 54 may be attached to substrate layer 108. In the illustrative configuration of FIG. 9, lamination equipment 138 is being used to laminate polarizer 54 to substrate layer 108. Lamination equipment 138 may include a roller laminator, vacuum lamination equipment, or other equipment for attaching polarizer 54 to substrate 108. When attached using roller-based lamination equipment or other lamination equipment, adhesive layer 98 (FIG. 6) attaches the lower surface of polarizer 54 to the upper surface of display layer 108 to form display stack 140, as shown in the bottom of FIG. 9.

In display stack 140, polarizer 54 has larger lateral dimensions than the corresponding lateral dimensions of layer 108. As a result, portions of polarizer layer 54 extend laterally beyond edge 110 of substrate 108 to form overhanging (overlapping) edge portions 142 of layer 54. Excess portion of polarizer 54 such as overhanging edge portions 142 can be removed following attachment of polarizer layer 54 to glass layer 108. For example, laser-based trimming equipment or other suitable trimming equipment can be used to remove some or all of overhanging edge portions 142 of polarizer layer 54.

Due to manufacturing variations, actual edge 110 of display layer 108 is generally ground to a shape that does not exactly match a target edge shape. Overgrinding and under-grinding scenarios may arise. The unique shapes of the display substrates that are produced by grinding tool 124 pose challenges for accurate polarizer trimming. As shown in FIG. 10, polarizer trimming operations may be performed using polarizer trimming equipment 200. Polarizer trimming equipment 200 may include a vision system such as vision system 202, a thickness gauge such as thickness gauge 164, a controller such as control unit 204 or other control circuitry, computer-controlled positioner 206, and laser 160. Vision system 202 may include a controller such as processor 208 or other control circuitry for processing image data from camera 210 (e.g., to extract edge positions, fiducial coordinates, etc.).

Vision system 202 may use camera 210 and processor 208 to gather raw and processed image data from display substrate 108 after grinding substrate 108 to produce peripheral edge 110. Vision system 118 of grinding tool 124 may also be used in gathering raw and processed image data from display substrate 108 after grinding substrate 108 to produce peripheral edge 110.

Based on knowledge of the characteristics of edge 110 that have been gathered using vision system 118 and/or vision system 202, system 200 (e.g., control unit 204 or other control circuitry) may be used in determining a desired laser cutting path for laser 160. Control circuitry such as control unit 204 may use positioner 206 to move laser 160 along the desired path around the periphery of display substrate 108. As laser 160 is moved along the edge of substrate 108, laser beam 162 trims away excess polarizer edges 142 (FIG. 9) so that the trimmed edge of polarizer 54 is aligned with ground edge 110 of substrate 108. Laser 160 may be an infrared laser such as a carbon dioxide laser operating at a wavelength of 9.6 microns, may be a visible light laser such as a laser operating at a wavelength of approximately 532 nanometers, or may be other suitable type of laser (as examples).

Vision system 202 may also be used to inspect display stack 140 following polarizer trimming operations. This may include, for example, assessing the quality of the edges of polarizer 54 and the quality of edges 110 of substrate 108. Raw and processed image data from display stack 140 following polarizer trimming operations may be used to determine whether or not substrate 108 has been damaged. If the edge quality of display stack 140 is unsatisfactory (e.g. if glass substrate 108 is damaged), the laser cutting path and/or laser characteristics may be adjusted prior to performing polarizer trimming operations on additional polarizers and display stacks.

Care must be taken to ensure that glass substrate 108 is not damaged by laser beam 162 during polarizer trimming operations. For example, if the focus position of laser 160 is too close to display layer 108, the heat of beam 162 may propagate into display layer 108 which may in turn cause damage to display layer 108.

To help prevent damage to display layer 108 while also allowing laser 160 to trim the edges of polarizer 54 to match edges 110 of display layer 108, the settings and position of laser 160 relative to polarizer 54 may be determined based on the unique size and/or shape of substrate 108. For example, a thickness gauge such as thickness gauge 164 may be used to determine the thickness T at one or more locations on display stack 140. By measuring the distance between upper surface 54U of polarizer 54 and lower surface 108L of glass substrate 108, the focal position of laser 160 can be set at a position relative to glass substrate 108 that effectively cuts polarizer 54 without damaging glass substrate 108.

Thickness gauge 164 may include one or more laser-based displacement sensors, laser-based thickness sensors, ultrasonic thickness gauges, contact probes, non-contact probes, and/or other thickness measurement tools. Thickness gauge 164 may be used to measure the thickness of display stack 140 at one location, at two locations, at three locations, at four locations, or at more than four locations on display stack 40. In one illustrative configuration, thickness gauge 164 measures the thickness of display stack 140 once at each of the four edges of display stack 140. Control circuitry such as control unit 204 may use positioner 166 to move thickness gauge 164 around display stack 140 so that thickness gauge 164 can measure the thickness of display stack 140 at multiple locations. This is, however, merely illustrative. If desired, thickness gauge 164 can be operated manually.

Control unit 204 may determine the mean thickness of each display stack 140 based on the thickness measurements gathered by thickness gauge 164. The mean thickness of a given display stack 140 may be used in determining the height H at which laser 160 should be located relative to polarizer 54 during polarizer trimming operations. For example, if the mean thickness of display stack 140 is T₁, then the distance H between laser 160 and polarizer 54 may be set equal to or nearly equal to T₁ with the focus position of laser beam 162 falling on upper surface 54U of polarizer 54. This allows the focus position of laser beam 162 to be manipulated during polarizer trimming operations without damaging glass substrate 108.

Optical structures such as lens 176 of FIG. 11 are used to focus laser beam 162. In the configuration of FIG. 11, the position of lens 176 is controlled by positioner 178. Positioner 178 is a computer-controlled positioner that receives control signals from control unit 204. In response, positioner 178 positions lens 176 and therefore laser beam 162 relative to layer 54 and edge 110 (FIG. 10). As shown in FIG. 11, lens 176 has a focal length F and focuses laser beam 162 to produce a spot of diameter D over a length L. Outside of length L, laser beam 162 becomes unfocused and is characterized by an enlarged spot size and reduced power density. The length of L may be determined by the configuration of lens 176 (e.g. L may be 50 to 2000 microns or less than 100 microns or more than 100 microns). The diameter D may be about 60-100 microns (as an example).

Polarizer trimming system 200 of FIG. 10 (e.g. control unit 204 or other control circuitry) may analyze the thickness measurements gathered by thickness gauge 164 and may optimize the settings of laser 160 (e.g. focal length, laser focus position, laser pulse energy, etc.) based on the thickness measurements. For example, control unit 204 may determine a mean thickness of display stack 140 based on the thickness measurements gathered by thickness gauge 164. The position of focused laser beam 162 and/or the focal length F may be adjusted based on the mean thickness of display stack 140. By taking the thickness of polarizer 54 and display layer 108 into account, polarizer trimming system 200 can effectively trim away excess portions of polarizer 54 without damaging display layer 108.

FIG. 12 is a top view of display substrate 108 following grinding to produce ground edge 110 and after oversized polarizer 54 has been laminated to the upper surface of display substrate 108 prior to trimming.

Laser 160 may make one or more passes along cutting path 220 to trim polarizer 54. If desired, the ablation energy of laser 160 may be modulated lower as the laser beam approaches substrate 108 (i.e. as the laser cut penetrates deeper into polarizer 54). For example, laser 160 may make 2, 3, 4, 5, or more than 5 passes along cutting path 220 at a first pulse energy. The pulse energy may then be reduced to a second pulse energy. The second pulse energy may, for example, be 5% to 10%, 10% to 15%, 15% to 20%, 20% to 25%, or 25% to 30% of the first pulse energy. Laser 160 may make 2, 3, 4, 5, or more than 5 passes along cutting path 220 at the second pulse energy. In one illustrative configuration, the second laser pulse energy ranges from 7% to 10% of the first laser pulse energy (i.e., the first laser pulse energy is reduced by at least 90%).

Care must be taken to ensure that the location at which laser 160 is turned on (shown in FIG. 12 as having coordinates (x₁, y₁) relative to edge 110 of substrate 108, sometimes referred to herein as the “switch-on location”) as it approaches cutting path 220 is not too close to substrate 108. Following laser trimming operations, vision system 202 of FIG. 10 may inspect the edges 110 of substrate 108 to assess whether or not substrate 108 has been damaged during polarizer trimming. If it is determined that substrate 108 has been damaged, the characteristics of laser cutting path 220 (e.g., the switch-on location of laser 160 relative to substrate 108) and/or the characteristics of laser 160 (e.g., the pulse energy of laser 160) may be adjusted accordingly prior to trimming the polarizer of additional display stacks.

For example, if trimming a polarizer in a first display stack using a 50 Watt laser that turns on at location (x₁, y₁) relative to the edge of the glass substrate results in a damaged glass substrate, then the polarizer in a second display stack may be trimmed using a 48 Watt laser that turns on at location (x₁′, y₁′) relative to the edge of the glass substrate (as an example). By assessing the quality of a polarizer trim prior to trimming subsequent polarizers, damage to subsequent polarizers can be avoided.

FIG. 13 is a flow chart of illustrative steps involved in forming electronic device displays with trimmed polarizers using equipment of the type shown in FIGS. 8, 9, and 10.

At step 300, grinding equipment 124 may be used to grind the edge of display substrate 108. The grinding process helps produce a smooth outer edge for display substrate 108. The grinding process also helps produce a shape for ground edge 108 that is close to a desired target edge shape. Due to manufacturing tolerances, however, each display substrate 108 that is ground in this way by grinding tool 124 will have a slightly different peripheral edge outline 110.

At step 302, an oversized layer of polarizer (i.e., a polarizer sheet with lateral dimensions that are larger than the lateral dimensions of substrate 108) may be laminated to the surface of display substrate 108 to form a display stack 140.

At step 304, thickness gauge 164 may be used to measure the thickness of display stack 140 at one or more locations on display stack 140. The thickness may be measured from an upper surface of polarizer 54 to a lower surface of glass layer 108.

At step 306, control unit 204 may determine the optimum settings for laser 160 based on the thickness measurements (e.g., the mean thickness of display stack 140). This may include, for example, positioning laser 160 at a distance from polarizer 54 that is equal to or nearly equal to the mean thickness of display stack 140 while focusing the laser beam on the upper surface of polarizer 54. If desired, other laser characteristics may be adjusted based on the thickness measurements gathered during step 316 (e.g., the focus position of laser beam 162 relative to substrate 108, the pulse energy of laser 160, the power of laser 160, the power density of laser beam 162, etc.).

At step 308, control unit 204 may direct positioner 206 to move laser 160 along the desired laser cutting path (e.g., path 220 of FIG. 12) to trim away excess polarizer.

At step 310, a vision system may be used to inspect the edges of polarizer 54 and/or the edges of glass substrate 108 to assess edge quality. This may include, for example, determining whether or not substrate 108 has been damaged during polarizer trimming operations. Based on the edge quality assessment, control unit 204 may make any necessary adjustments to the laser parameters prior to performing polarizer trimming operations on additional display stacks. For example, if it is determined that edge 110 of substrate 108 has been damaged, control unit 204 may adjust the power of laser 160 and/or the switch-on position of laser 160 (relative to the display stack) prior to trimming additional display polarizers.

Following polarizer trimming, additional display components may be added and display 14 may be formed in device housing 12 of device 10.

The foregoing is merely illustrative and various modifications can be made by those skilled in the art without departing from the scope and spirit of the described embodiments. The foregoing embodiments may be implemented individually or in any combination.

1. A method of trimming a layer of polarizer from a display substrate using a laser, comprising:
with a thickness gauge, measuring a distance between an upper surface of the layer of polarizer and a lower surface of the display substrate;
adjusting a position of the laser relative to the layer of polarizer based on the distance; and
with the laser, applying a laser beam to the layer of polarizer to trim away an excess edge portion of the layer of polarizer.

2. The method defined in claim 1 wherein adjusting the position of the laser relative to the layer of polarizer comprises positioning the laser at a height relative to the layer of polarizer, wherein the height corresponds to the distance.

3. The method defined in claim 2 wherein applying the laser beam to the layer of polarizer comprises applying the laser beam to the layer of polarizer while maintaining the height of the laser relative to the layer of polarizer.

4. The method defined in claim 1 wherein applying the laser beam to the layer of polarizer comprises:
applying the laser beam with a first laser pulse energy to the layer of polarizer;
reducing the first laser pulse energy to a second laser pulse energy; and
applying the laser beam with the second laser pulse energy to the layer of polarizer.

5. The method defined in claim 1 wherein reducing the first laser pulse energy to the second laser pulse energy comprises reducing the first laser pulse energy by at least 90%.

6. The method defined in claim 1 wherein the display substrate comprises a glass display substrate having a peripheral edge and wherein applying the laser beam to the layer of polarizer comprises laser cutting through the layer of polarizer so that a peripheral edge of the layer of polarizer matches the peripheral edge of the glass display substrate.

7. The method defined in claim 1 wherein measuring the distance between the upper surface of the layer of polarizer and the lower surface of the display substrate comprises measuring the distance at multiple locations on the layer of polarizer.

8. A method of trimming a first polarizer from a first display substrate and a second polarizer from a second display substrate using a laser, comprising:
with the laser, applying a laser beam using a first set of laser parameters to the first polarizer to trim away an excess edge portion of the first polarizer;
with a vision system, performing an inspection of the first display substrate and determining whether the first display substrate is damaged;
based on the inspection, adjusting the first set of laser parameters to a second set of laser parameters; and
with the laser, applying the laser beam using the second set of laser parameters to the second polarizer to trim away an excess edge portion of the second polarizer.

9. The method defined in claim 8 wherein the first set of laser parameters comprises a first location of the laser relative to the first display substrate at which the laser is turned on and wherein the second set of laser parameters comprises a second location of the laser relative to the second display substrate at which the laser is turned on.

10. The method defined in claim 8 wherein the first set of laser parameters comprises a first laser pulse energy of the laser beam, wherein the second set of laser parameters comprises a second laser pulse energy of the laser beam, and wherein adjusting the first set of laser parameters to the second set of laser parameters comprises reducing the first laser pulse energy to the second laser pulse energy.

11. The method defined in claim 8 further comprising:
using a thickness gauge, measuring a first thickness of the first polarizer and the first display substrate; and
positioning the laser relative to the first polarizer based on the first thickness.

12. The method defined in claim 11 further comprising:
using the thickness gauge, measuring a second thickness of the second polarizer and the second display substrate; and
positioning the laser relative to the second polarizer based on the second thickness.

13. The method defined in claim 11 wherein positioning the laser relative to the first polarizer comprises positioning the laser at a height relative to first polarizer, wherein the height corresponds to the first thickness.

14. The method defined in claim 13 wherein applying the laser beam using the first set of laser parameters to the first polarizer comprises applying the laser beam to the first polarizer while maintaining the height of the laser relative to the first polarizer.

15. Polarizer trimming equipment configured to trim a polarizer from a display substrate, comprising:
a thickness gauge that gathers thickness information from the polarizer and the display substrate;
a laser that applies a laser beam to the polarizer; and
a computer-controlled positioner that adjusts a position of the laser relative to the polarizer based on the thickness information and that moves the laser along a laser cutting path to trim away excess portions of the polarizer.

16. The polarizer trimming equipment defined in claim 15 further comprising a vision system configured to determine whether or not the display substrate is damaged following laser trimming operations.

17. The polarizer trimming equipment defined in claim 16 further comprising a control unit coupled to the thickness gauge, the laser, and the vision system, wherein the control unit is configured to adjust laser parameters associated with the laser based on information from the thickness gauge and the vision system.

18. The polarizer trimming equipment defined in claim 17 wherein the laser parameters are selected from the group consisting of: focal length, laser focus position relative to the polarizer, and laser pulse energy.

19. The polarizer trimming equipment defined in claim 16 further comprising an additional computer-controlled positioner that adjusts a position of the thickness gauge relative to the polarizer.

20. The polarizer trimming equipment defined in claim 15 wherein the thickness gauge comprises a contact probe.
